(19) United States
(12) Patent Application Publication
(10) Pub. No.: US 2026/0061945 A1
(43) Pub. Date: Mar. 5, 2026

(54) VEHICLE HAVING ENTERTAINMENT SYSTEM

(71) Applicant: Honda Motor Co., Ltd., Tokyo (JP)

(72) Inventors: Saul Mijael IBAVEN BUENO, Columbus, OH (US); Jordan A. Reeves, Bellefontaine, OH (US); Katherine Susanne Smith, St. Marys, OH (US); Zachary G. Segraves, Grandview Heights, OH (US)

(21) Appl. No.: 18/823,154

(22) Filed: Sep. 3, 2024

(51) Int. Cl. B60R 11/02; B60K 35/22; B60R 11/00; G03B 21/58

(52) U.S. Cl. CPC B60R 11/0229; B60K 35/22; B60R 11/0217; G03B 21/58; B60K 2360/334; B60K 2360/66; B60R 2011/0015; B60R 2011/0028; B60R 2011/0082

(57) ABSTRACT

A vehicle includes a vehicle body defining a passenger compartment and a tailgate area arranged rearwardly of the passenger compartment and having an opening to provide access of the tailgate area. The vehicle also includes a tailgate pivotally coupled to the vehicle body and arranged to selectively cover the opening of the tailgate area. Moreover, the vehicle includes a display screen arranged to be displaced between a stowed position and a deployed position. Furthermore, the vehicle includes a projector configured to project a visual media content on the display screen arranged at the deployed position. The display screen is mounted to the ceiling of the vehicle and inside the tailgate area when the projector is mounted to the tailgate, or the display screen is mounted to tailgate when the projector is mounted to the ceiling of the vehicle and is arranged inside the tailgate area.

### BACKGROUND

The disclosed subject matter relates generally to vehicles. More particularly, the disclosed subject matter relates to a vehicle having an entertainment system suitable to play audio and visual media content for people gathered around the vehicle.

When users attend a tailgate or other outdoor party or activity, they often have the desire to play audio-visual media content. Currently there are multiple options for personal media enjoyment, but options for sharing that content with a larger group at an event or activity centered around a vehicle area limited. Most solutions are either custom or require set up outside of vehicle, and large and difficult to pack in a vehicle or set up outdoors.

### SUMMARY

In accordance with one embodiment of the present disclosure, a vehicle is disclosed. The vehicle includes a vehicle body defining a passenger compartment and a tailgate area arranged rearwardly of the passenger compartment and having an opening to provide access of the tailgate area from a rear end of the vehicle body. The vehicle also includes a tailgate pivotally coupled to the vehicle body and arranged to selectively cover the opening of the tailgate area. Moreover, the vehicle includes a display screen arranged to be displaced between a stowed position and a deployed position. Furthermore, the vehicle includes a projector configured to project a visual media content on the display screen arranged at the deployed position. The display screen is mounted to the ceiling of the vehicle and inside the tailgate area when the projector is mounted to the tailgate, or the display screen is mounted to tailgate when the projector is mounted to the ceiling of the vehicle and is arranged inside the tailgate area.

In accordance with another embodiment of the present disclosure, a vehicle is provided. The vehicle includes a vehicle body defining a passenger compartment and a tailgate area arranged rearwardly of the passenger compartment and having an opening to provide access of the tailgate area from a rear end of the vehicle body. The vehicle also includes a tailgate pivotally coupled to the vehicle body and arranged to selectively cover the opening of the tailgate area. Further, the vehicle includes a display screen arranged to be displaced between a stowed position and a deployed position. Moreover, the vehicle includes a projector configured to project a visual media content on the display screen arranged at the deployed position. Furthermore, the vehicle includes a speaker hub arranged inside the vehicle body and forwardly of the display screen to receive an audio from an external gadget and play the audio received from the external gadget. The display screen is mounted to the ceiling of the vehicle and inside the tailgate area when the projector is mounted to tailgate, or the display screen is mounted to the tailgate when the projector is mounted to the ceiling of the vehicle and is arranged inside the tailgate area.

In accordance with a further embodiment of the present disclosure, a vehicle is disclosed. The vehicle includes a vehicle body including a pair of sidewalls and defining a passenger compartment and a tailgate area arranged rearwardly of the passenger compartment and having an opening to provide access of the tailgate area from a rear end of the vehicle body. The vehicle also includes a tailgate pivotally coupled to the vehicle body and arranged to selectively cover the opening of the tailgate area. The vehicle further includes a display screen arranged to be displaced between a stowed position and a deployed position and mounted to the ceiling of the vehicle and inside the tailgate area. Moreover, the vehicle includes a projector mounted to the tailgate and configured to project a visual media content on the display screen arranged at the deployed position. Furthermore, the vehicle includes a speaker hub arranged inside the vehicle body and forwardly of the display screen to receive an audio from an external gadget and play the audio received from the external gadget. Also, the vehicle includes at least one auxiliary speaker communicatively coupled to the speaker hub to play the audio received from the external gadget, wherein the at least one speaker is removably mounted to at least one sidewall of the pair of sidewalls.

### BRIEF DESCRIPTION OF THE DRAWINGS

Certain embodiments of the present disclosure will be better understood from the following description taken in conjunction with the accompanying drawings in which:

FIG. 1 is a side perspective view of a vehicle having an entertainment system with a projector mounted to a tailgate, in accordance with one embodiment of the present disclosure;

FIG. 2 is a rear view of a rear portion of the vehicle of FIG. 1 depicting a display screen of the entertainment system mounted inside a tailgate area and arranged at a deployed position, in accordance with one embodiment of the present disclosure;

FIG. 3 is a rear perspective view of the rear portion of the vehicle of FIG. 1 depicting the display screen arranged at a stowed position, in accordance with one embodiment of the present disclosure;

FIG. 4 is a side perspective view of a vehicle having a display screen mounted to a tailgate and arranged at a deployed position, in accordance with one embodiment of the present disclosure; and

FIG. 5 is a rear perspective view of the rear portion of the vehicle of FIG. 4 depicting the display screen arranged at a stowed position and a projector mounted to a ceiling and arranged inside a tailgate area of the vehicle, in accordance with one embodiment of the present disclosure.

### DETAILED DESCRIPTION OF EXEMPLARY EMBODIMENTS

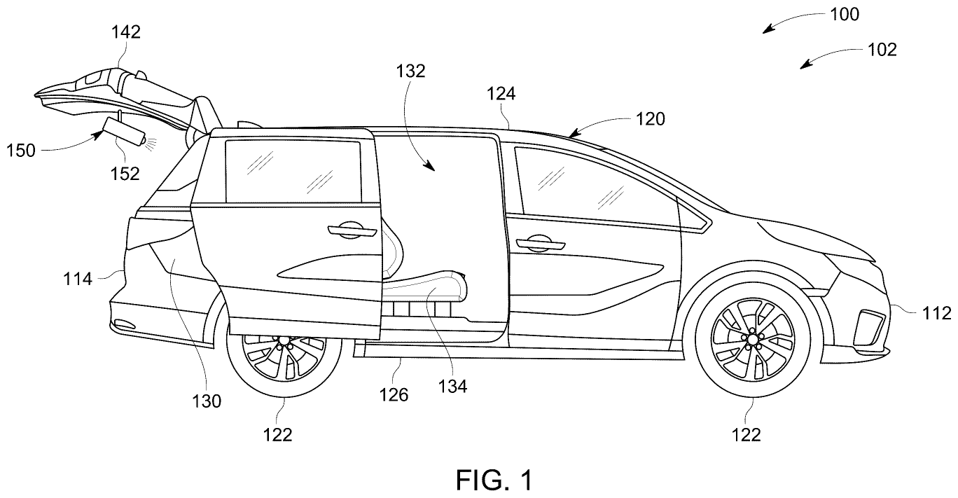

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-5, wherein like numbers indicate the same or corresponding elements throughout the views.

FIG. 1 illustrates a perspective view of a vehicle, indicated generally at 100, in accordance with one embodiment of the present disclosure. The vehicle 100 is shown as a van 102, however, the vehicle 100 in accordance with alternative embodiments can comprise any variety of vehicle, including hatchback, sport utility vehicles, jeeps, truck, etc., for example. The vehicle 100 includes a front end 112, a rear end 114, a first longitudinal side 116 (hereinafter referred to as a left side 116), a second longitudinal side 118 (hereinafter referred to as a right side 118), and a vehicle body 120 extending from the front end 112 to the rear end 114 and supported on a plurality of wheels 122.

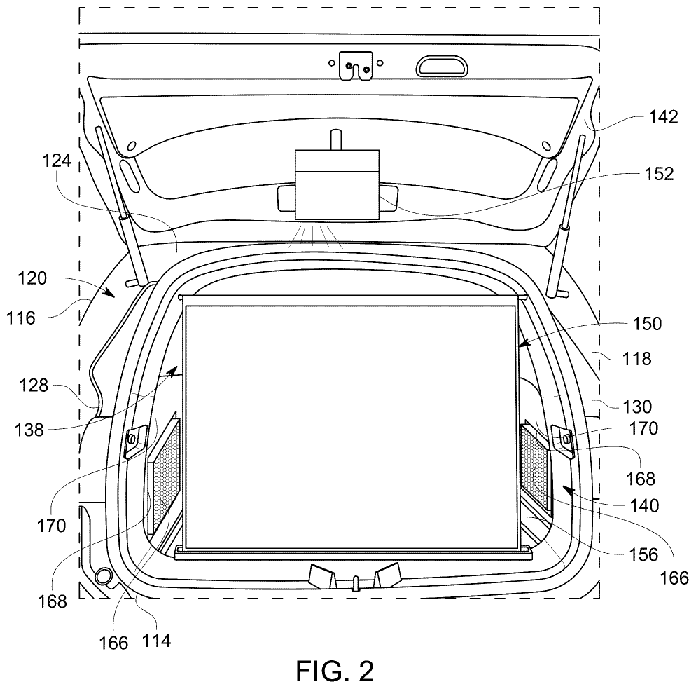

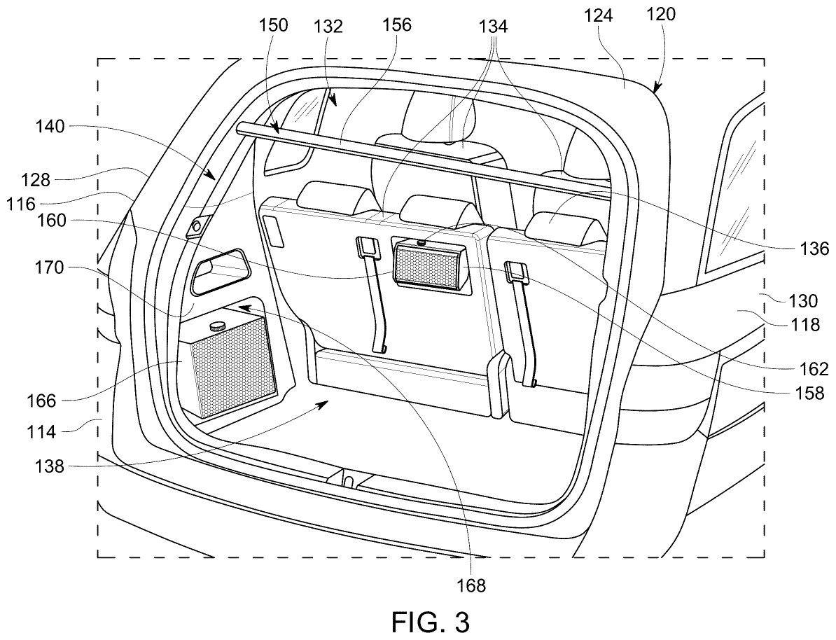

As shown in FIGS. 2 and 3, the vehicle body 120 has a roof i.e., ceiling 124, a floor 126, and a pair of sidewalls 128, 130 extending along the longitudinal sides 116, 118 of the vehicle 100 and supporting the roof 124. The vehicle body 120 defines a passenger compartment 132 including a plurality of seats 134 having one or more rear seats 136 to facilitate a seating of a plurality of passengers including a driver inside the vehicle 100. Further, the vehicle body 120 defines a tailgate area 138 i.e., storage compartment 138 that extends rearwardly of the rear seats 136 of the vehicle 100. Moreover, the vehicle body 120 defines an opening 140, i.e., a rear opening 140, of the storage compartment 138 to enable an access of the storage compartment 138 from a rear of the vehicle 100. As shown in FIGS. 2 and 3, the rear opening 140 is arranged at the rear end 114 of the vehicle 100 and the vehicle 100 includes a tailgate 142 pivotally coupled to the vehicle body 120, for example, the roof 124, and adapted to pivot between an open position (shown in FIGS. 2 and 3) to allow access of the rear opening 140 and a closed position to close the rear opening 140.

Moreover, the vehicle 100 includes an entertainment system 150 having a projector 152, a display screen 156, and at least one speaker 158. As shown in FIGS. 1 and 2, the projector 150 is mounted to the tailgate 142 at a location that is suitable to project the media content, for example, visual media content on the display screen 156. As shown, the projector 152 is arranged substantially centrally, in the lateral direction, to the tailgate 142 and is adapted to be manipulated to properly focus the media content, i.e., visual media content, on the display screen 156. Further, the display screen 156 is arranged inside the storage compartment 138 and proximate to the rear opening 140. The display screen 156 is mounted to the vehicle body 120 either to the roof 124 or the sidewalls 128, 130 of the vehicle body 120 and is adapted to be arranged/moved/displaced between a retracted/stowed position (shown in FIG. 3) and a deployed position (shown in FIG. 2). In the retracted position, shown in FIG. 3, the display screen 156 is arranged in a cylindrical rolled configuration, while in the deployed position, the display screen 156 is arranged covering, at least partially, the rear opening 140, and facilitates a display of a media i.e., visual media, content projected by the projector 152 on the display screen 156.

Moreover, referring to FIG. 3, the at least one speaker 158 includes a speaker hub 160 arranged inside the vehicle body 120 and configured to play the audio content. In the illustrated embodiment, the speaker hub 160 is mounted to the rear seat 1136 and is arranged forwardly of the display screen 156. However, the speaker hub 160 may be mounted to any other suitable component of the vehicle 100, while being arranged inside the vehicle body 120. Accordingly, the display screen 156 is arranged in the path of the audio generated by the speaker hub 160. To reduce the absorbtion and/or reflection of the audio signals generated by the speaker hub 160, the display screen 156 is made of material having high sound transmission capability. Therefore, the display screen 156 is an acoustically transparent screen. Additionally, the speaker hub 160 includes a communication hub 162 that facilitates a pairing of an external device/gadget, for example, a mobile phone or head mounted device, with the projector 152 to enable a data transfer between the external device and the projector 152 and the external device and the speaker hub 160. Moreover, the projector 152 is configured to receive visual media content from the external device and display the visual media content on the display screen 156. Further, the speaker hub 160 is connected with the external device and the projector 152 such that the speaker hub 162 is adapted to play the audio content associated with the visual media content displayed on the display screen 156 or any other the audio content provided by the external device.

Further, the at least one speaker 158 includes at least one auxiliary speaker 166, two auxiliary speakers 166, adapted to be removably arranged inside the storage compartment 138 and configured to communicate with the speaker hub 160 to receive the signal corresponding to the audio content from the speaker hub 160 and play the audio content in sync with the speaker hub 160. As shown in FIGS. 2 and 3, the auxiliary speakers 166 are removably arranged inside pockets 168 defined by sideliners 170 attached to the sidewalls 128, 130 of the vehicle body 120. It may be appreciated that the auxiliary speakers 166 may be removed from the pockets 168 and arranged outside the vehicle 100 for playing the audio content. Further, the auxiliary speakers 166 may include suitable stands, facilitating the suitable positioning of the auxiliary speakers 166 outside the vehicle 100 and in proximity to the vehicle 100. It may be appreciated that the auxiliary speakers 166 may be connected to the speaker hub 160 using wires or without wires, i.e., wirelessly using suitable wireless communication devices, for example, Wi-Fi, Bluetooth, etc. In this manner, the entertainment system 150 is utilized to play audio and visual media content for people gathered around the vehicle 100 without any additional external devices needed to the play the media content. Moreover, the projector 152 and the speakers 160, 166 may be connected with an infotainment system of the vehicle 100 to play the media content from the infotainment system 100.

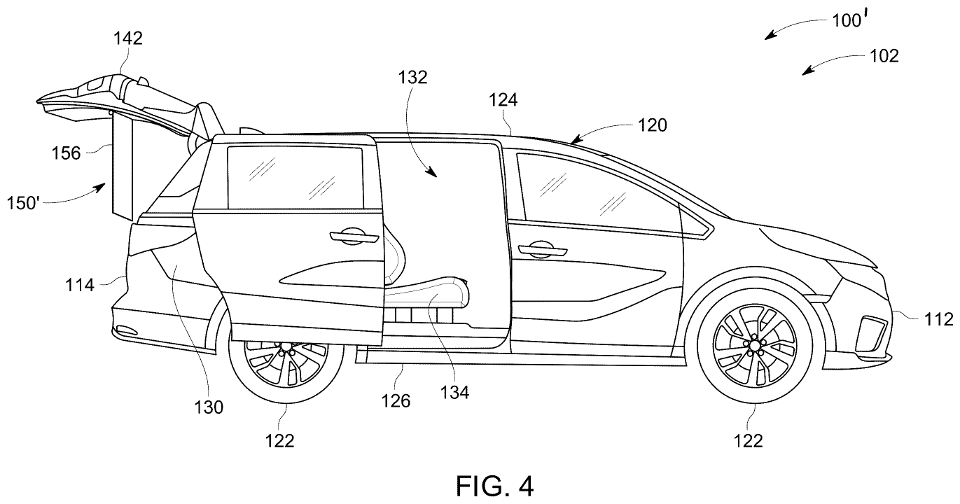

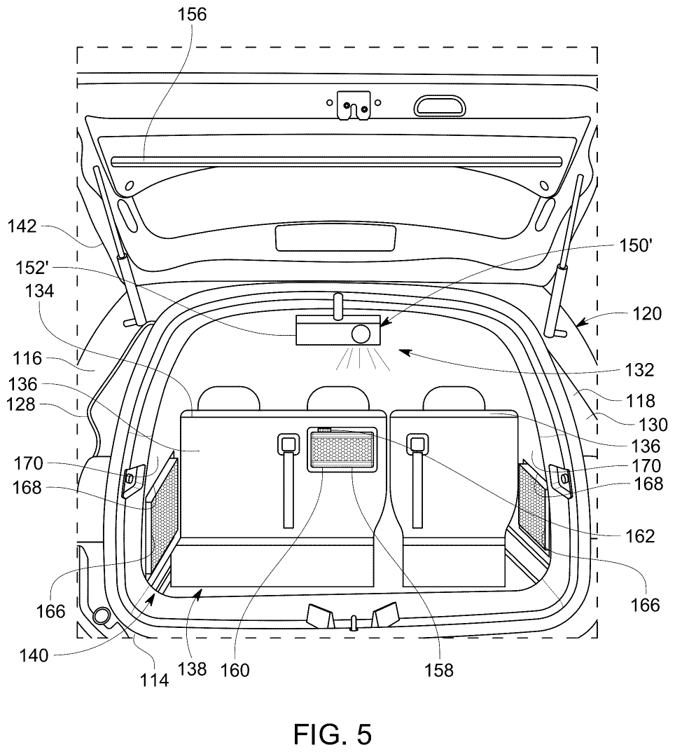

Referring to FIGS. 4 and 5, a vehicle 100′ having an entertainment system 150′ is shown, according to another embodiment of the disclosure. As shown, the vehicle 100′ is similar to the vehicle 100 except that the entertainment system 150′ of the vehicle 100′ is different from the entertainment system 150 of the vehicle 100 in the mounting/positioning of one or more components of the entertainment system 150 to the vehicle 100. As shown, the entertainment system 150′ includes a projector 152′, shown in FIG. 5, that is mounted to the roof i.e., ceiling 124 of the vehicle 100′ and is arranged inside a tailgate area i.e., storage compartment 138 of the vehicle 100′, while the display screen 156 is mounted to the tailgate 142, as shown in FIG. 4. In some embodiments, the display screen 156 is adapted to be moved to the deployed position when the tailgate 142 is arranged at the open position. In some embodiments, a controller of the vehicle 100′ or the entertainment system 150′ may check a position of the tailgate 142 before moving the display screen 156 to the deployed position and allows the displacement of the display screen 156 to the deployed position from the stowed position when the tailgate 142 is arranged at the position. Also, the projector 152′ is adapted for rear projection to project the visual media content on the display screen 156 from a rear of the display screen 156. Other components of the entertainment system 150′, i.e., the speaker hub and the auxiliary speakers are identical to the entertainment system 150 and are identically mounted to the vehicle 100′.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A vehicle, comprising:
a vehicle body defining a passenger compartment and a tailgate area arranged rearwardly of the passenger compartment and having an opening to provide access of the tailgate area from a rear end of the vehicle body;
a tailgate pivotally coupled to the vehicle body and arranged to selectively cover the opening of the tailgate area;
a display screen arranged to be displaced between a stowed position and a deployed position; and
a projector configured to project a visual media content on the display screen arranged at the deployed position,
wherein the display screen is mounted to the ceiling of the vehicle and inside the tailgate area when the projector is mounted to the tailgate, or
the display screen is mounted to tailgate when the projector is mounted to the ceiling of the vehicle and is arranged inside the tailgate area.

2. The vehicle of claim 1 further including a speaker hub arranged inside the vehicle body to receive an audio from an external gadget and play the audio received from the external gadget.

3. The vehicle of claim 2, wherein the speaker hub is communicatively coupled to the projector and facilitates a connection of the projector with the external gadget to enable a receipt of the visual media content from the external gadget and a projection of the visual media content received from the external gadget.

4. The vehicle of claim 2, wherein the speaker hub is arranged forwardly of the display screen.

5. The vehicle of claim 4, wherein the speaker hub is mounted to a rear seat of the vehicle.

6. The vehicle of claim 4, wherein the display screen is an acoustically transparent screen.

7. The vehicle of claim 2 further including at least one auxiliary speaker communicatively coupled to the speaker hub to play the audio received from the external gadget.

8. The vehicle of claim 7, wherein
the vehicle body includes a pair of sideliners attached to a pair of sidewalls of the vehicle body, and
at least one sideliner of the pair of sideliners defines a pocket to removably receive the at least one auxiliary speaker.

9. The vehicle of claim 1, wherein the display screen is mounted to tailgate and the display screen is adapted to be moved to the deployed position when the tailgate is arranged at an open position.

10. A vehicle, comprising:
a vehicle body defining a passenger compartment and a tailgate area arranged rearwardly of the passenger compartment and having an opening to provide access of the tailgate area from a rear end of the vehicle body;
a tailgate pivotally coupled to the vehicle body and arranged to selectively cover the opening of the tailgate area;
a display screen arranged to be displaced between a stowed position and a deployed position;
a projector configured to project a visual media content on the display screen arranged at the deployed position; and
a speaker hub arranged inside the vehicle body and forwardly of the display screen to receive an audio from an external gadget and play the audio received from the external gadget,
wherein the display screen is mounted to the ceiling of the vehicle and inside the tailgate area when the projector is mounted to tailgate, or
the display screen is mounted to the tailgate when the projector is mounted to the ceiling of the vehicle and is arranged inside the tailgate area.

11. The vehicle of claim 10, wherein the speaker hub is communicatively coupled to the projector and facilitates a connection of the projector with the external gadget to enable a receipt of the visual media content from the external gadget and a projection of the visual media content received from the external gadget.

12. The vehicle of claim 10, wherein the speaker hub is mounted to a rear seat of the vehicle.

13. The vehicle of claim 10, wherein the display screen is an acoustically transparent screen.

14. The vehicle of claim 10 further including at least one auxiliary speaker communicatively coupled to the speaker hub to play the audio received from the external gadget.

15. The vehicle of claim 14, wherein
the vehicle body includes a pair of sideliners attached to a pair of sidewalls of the vehicle body, and
at least one sideliner of the pair of sideliners defines a pocket to removably receive the at least one auxiliary speaker.

16. A vehicle, comprising:
a vehicle body including a pair of sidewalls and defining a passenger compartment and a tailgate area arranged rearwardly of the passenger compartment and having an opening to provide access of the tailgate area from a rear end of the vehicle body;
a tailgate pivotally coupled to the vehicle body and arranged to selectively cover the opening of the tailgate area;
a display screen arranged to be displaced between a stowed position and a deployed position and mounted to the ceiling of the vehicle and inside the tailgate area;
a projector mounted to the tailgate and configured to project a visual media content on the display screen arranged at the deployed position;
a speaker hub arranged inside the vehicle body and forwardly of the display screen to receive an audio from an external gadget and play the audio received from the external gadget; and
at least one auxiliary speaker communicatively coupled to the speaker hub to play the audio received from the external gadget, wherein the at least one speaker is removably mounted to at least one sidewall of the pair of sidewalls.

17. The vehicle of claim 16, wherein the speaker hub is communicatively coupled to the projector and facilitates a connection of the projector with the external gadget to enable a receipt of the visual media content from the external gadget and a projection of the visual media content received from the external gadget.

18. The vehicle of claim 16, wherein the speaker hub is mounted to a rear seat of the vehicle.

19. The vehicle of claim 16, wherein
the vehicle body includes a pair of sideliners attached to the pair of sidewalls, and
at least one sideliner of the pair of sideliners defines a pocket to removably receive the at least one auxiliary speaker.

20. The vehicle of claim 16, wherein the display screen is an acoustically transparent screen.
